(19) United States
(12) Patent Application Publication
(10) Pub. No.: US 2012/0179757 A1
(43) Pub. Date: Jul. 12, 2012

(54) SYSTEM AND PROCESS FOR COMMUNICATION AND PROMOTION OF AUDIO WITHIN A SOCIAL NETWORK

(75) Inventors: Troy Allen Jones, Frisco, TX (US); Malcolm Miller, Plano, TX (US)

(73) Assignee: Troy Allen Jones, Frisco, TX (US)

(21) Appl. No.: 13/347,556

(22) Filed: Jan. 10, 2012

Related U.S. Application Data
(60) Provisional application No. 61/431,078, filed on Jan. 10, 2011.

(51) Int. Cl. G06F 15/16

(52) U.S. Cl. 709/204

(57) ABSTRACT

The present invention is directed to system and process for communication and promotion of media within a social network or mobile device A media library is created by upload a plurality of media segments and associating the media segments with search data such as mood, genre, and keywords. The media library is retrievable stored on a media server, which is in communication with an application server and a plurality of clients. A client is used to search and select a media segment, which is basis of a digital media package. The digital media package is delivered to the social media space of a selected recipient. The members of the recipient's social network interact with the digital media package. The social media package interaction is captured and stored. The system processes the search and selection criteria along with the social media interaction to form a feedback loop to improve future searches and thus improve the promotion of the media.

### FIELD OF THE INVENTION

This application claims priority and benefit over U.S. Provisional Patent Application No. 61/431,078—filing or 37(c) date Jan. 10, 2011. The present invention relates to a system and process for communication and promotion of audio, more specifically to a system and process for communication and promotion of audio within a social network.

### BACKGROUND OF THE RELATED ART

For years, the music and entertainment industry has struggled with how to keep pace with technology advancements related to the promotion and selling of music and film. Traditional methods of marketing have involved “push” techniques, which often prove unsuccessful in the social media environment because significant number of users are not receptive to that style of marketing. As a result, a more user friendly and less intrusive approach to marketing music and other content is needed in today's social media environment.

Today, sharing entire songs or movies as a way to communicate is not practical because of the length and file size of the material. Additionally, users do not have a way to access this material by mood, feeling, subject matter, or topic they want to communicate. Therefore, in order to effectively address this gap, users must have an easy way to find digital content that relates to their personal mood or feeling and able to share it in a way that integrate with and enhances the social experience.

The organization of content in this fashion solves the problem of helping the sender find the right content that reinforces the message they are trying to convey. In music, there are ten of thousands of compositions of lyrics and rhythms to match many occasions. The right message has probably been said in song. However, the problem has been in locating the right song for the occasion among all of the available compositions.

Artists and the promoters of music aspire for their song to become a “meme.” With traditional push marketing, sales tend to have a linear correlation to the spending on the push. On the other hand, once a song or segment thereof becomes a meme, its popularity and corresponding sales can grow geometrically. The data from users associating feelings of special events with specific songs is difficult to achieve in traditional “push” marketing.

For the above reasons, it would be advantageous to have a system and process, which integrates media into a versatile digital media package extensively personalized by the sender for presentation in a social network.

### SUMMARY

The present invention is directed to system and process for communication and promotion of media within a social network. A media library is created by upload a plurality of media segments and associating the media segments with search data such as mood, genre, and keywords. The media library is retrievable stored on a media server that is in communication with an application server and a plurality of clients. A client is used to search and select a media segment, which is basis of a digital media package. The digital media package is delivered to the social media space of a selected recipient. The members of the recipient's social network interact with the digital media package. The social media package interaction is captured and stored. The system processes the search and selection criteria along with the social media interaction to form a feedback loop to improve future searches and thus improve the promotion of the media.

These and other features, aspects, and advantages of the invention will become better understood with reference to the following description, and accompanying drawings.

### BRIEF DESCRIPTION OF THE DRAWINGS

FIG. 1 depicts a block diagram of major components of the system for an embodiment of the current invention;

FIG. 2 depicts a layer diagram for the audio library of FIG. 1;

FIG. 3 depicts a flowchart for creating the audio library of FIG. 1;

FIG. 4 depicts a flowchart for the use of a client of FIG. 1;

FIG. 5 depicts the installation of a client of FIG. 1;

FIG. 6 depicts interaction with the client of FIG. 5;

FIG. 7 depicts interaction with the client of FIG. 5;

FIG. 8 depicts interaction with the client of FIG. 5;

FIG. 9 depicts a presentation layer of data within a digital media package;

FIG. 10 depicts an embedded object for integration into external systems;

FIG. 11 depicts an interface activated from the embedded object of FIG. 10;

### DETAILED DESCRIPTION

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

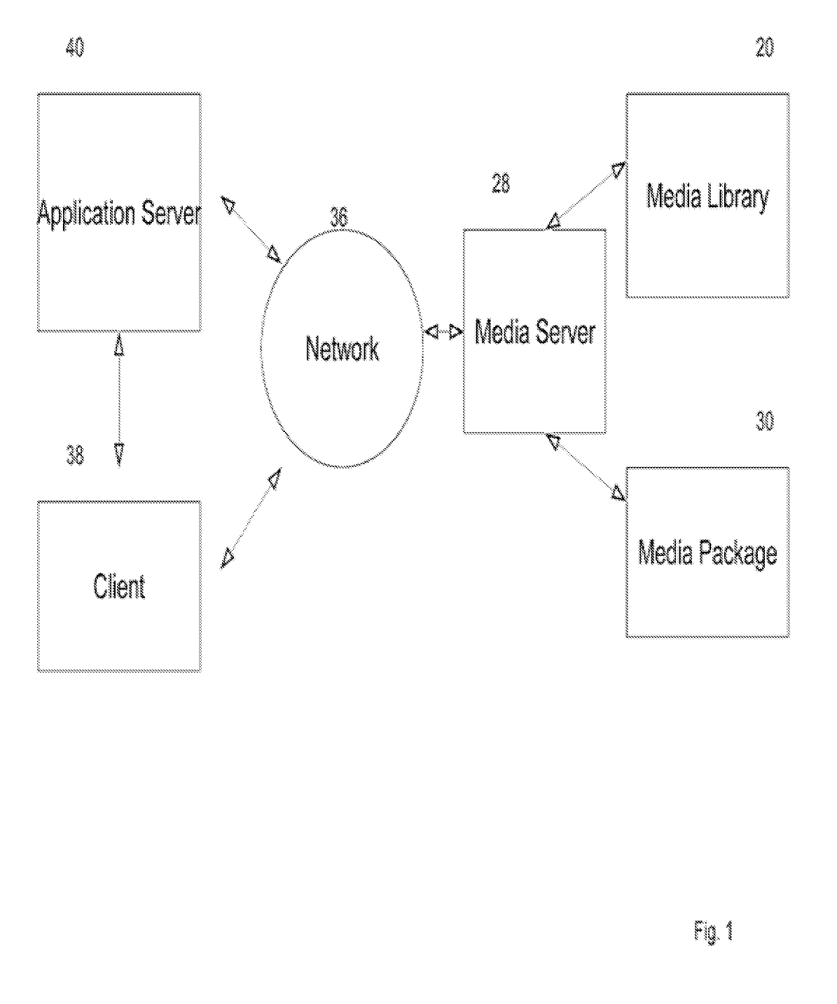

The present invention is directed to a system and process for creating, distributing, and interacting with a digital media package. FIG. 1 illustrates an embodiment of the system of the present invention. Depicted are a media library 20, a media server 28, a network 36, an application server 40, and a client 38.

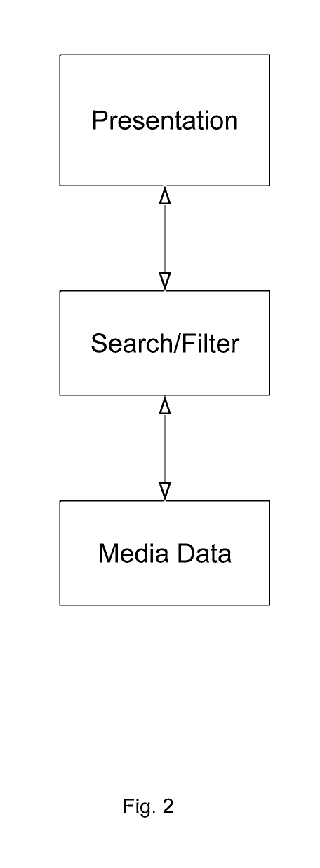

The media library 20 is a database composed of a plurality of records containing media segments and associated data. The three primary layers of the media library 20 are depicted in FIG. 2. The media data layer 22 is contains the core data of the system, namely media data itself. The preferred media data is audio in the form of music, although media data as used in this application can include podcasts, speeches, sound bytes, video clips, television clips, film clips, and the like. The media data can be stored in the formats available in the art. Audio segments can be stored in formats such as MP3, WAV, AIFF, FLAG, Ogg, WMA, or other formats known in the art. Video segments can be stored in AVI, MPG, QuickTime, or other formats known in the art. A record containing the media data may also contain associated data such as the category or categories, the mood evoked, the content author, access privileges, access log, ratings, keywords, title, author, and other searchable information.

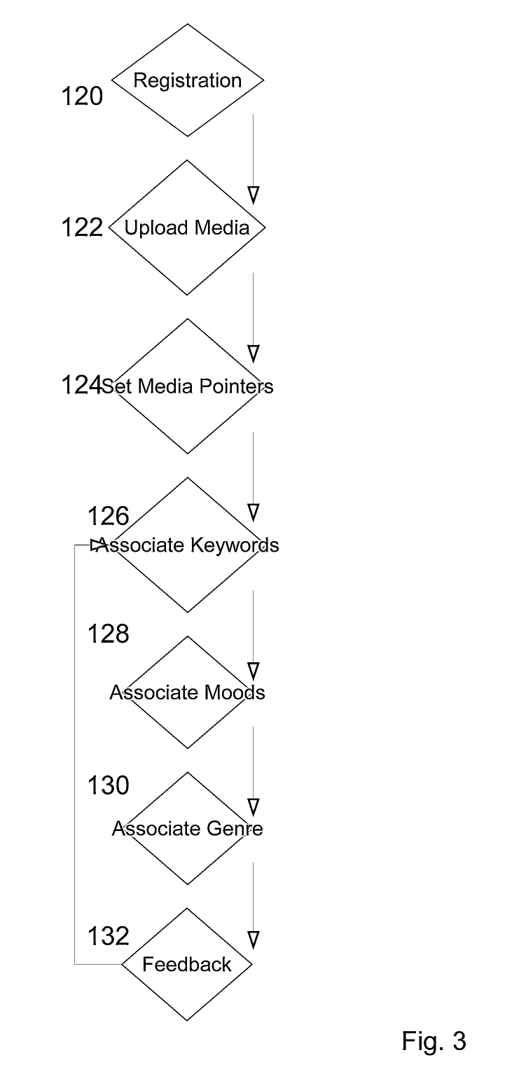

An embodiment of the process to initially create the media library 20 is depicted in FIG. 3. First, a media author creates a profile in the system 120. The media author enters information to enable social network member searches and to process or receive payments.

The information includes but is not limited to contact information, bibliographic information, artist name, credit card numbers, bank account numbers, or PayPal account data. After registering a profile 120, the media author is prompted to upload the media data 122, typically a complete song, into the media library 20. The media author is prompted to select a segment of the media 124, with the preferable length being about thirty seconds. The system may preprocess the media for audio characteristics such as amplitude, voice analysis, or lookup into external databases with time table to determine segments which contain verses, refrains, tempos, desired lyrics, or other characteristics which would aid input or searching for the segment based on mood, genre, or keywords. The system may present the media author with the results of the preprocessing for approval or editing. The system then stores the start and stop pointers for the desired segment. The system may truncate the media outside those bounds and only store the desired segment. Alternatively, the system may store the entire media upload and also store the segment pointers for communication to a media player. Additionally, the media author may also upload associated secondary media such as album artwork, labels, or the like.

After successful upload of the media 122, the media author is prompted to enter additional associated data to enable social network members to locate the media segment. The media author can associate keywords to the media segment 126. The media author can input any text preferably inputs text which matches or has the potential to match certain moods, events, social network member search patterns, or “memes.” The system may aid or suggest keywords based on the processing of the segment. Besides the aforementioned processing, such as lyric retrieval from external tables, the system may retrieve and suggest keywords based on other media data 22 within the media library, which contains similar characteristics. Thus the system may suggest keywords based on the lyrics, tempo, or amplitude. The associated keywords are stored along with the media segment.

Upon association of keywords to the media segment 126, the media author is prompted to input or select moods associated with the media segment 128. The media author can input text or select colors associated with common moods. Again, the system may aid or suggest moods based on the processing of the segment or other media segments in the media library 20 with similar characteristics. The associated moods are stored along with the media segment.

Upon association of moods to the media segment 128, the media author is prompted to input genres associated with the media segment 130. The author can input text or select from common genre. Again, the system may aid or suggest genre based on the processing of the segment or other media segments in the media library 20 with similar characteristics. The associated genre is stored along with the media segment.

The media library 20 is stored on a media server 28. A computer or server as referred to in this specification generally refers to a system, which includes a central processing unit (CPU), memory, a screen, a network interface, and input/output (I/O) components connected by way of a data bus. The I/O components may include for example, a mouse, keyboard, buttons, or a touch screen. The network interface enables data communications with the computer network 36. A server contains various server software programs and preferably contains application server software. Those skilled in the art will appreciate that computer and servers may take a variety of configurations, including personal computers, hand-held devices, multi-processor systems, microprocessor-based electronics, network PCs, minicomputers, mainframe computers, and the like. Additionally, computers and servers may be part of a distributed computer environment where tasks are performed by local and remote processing devices that are linked.

The communication network 36 includes a computer network and a telephone system. The computer network 36 includes of a variety of network components and protocols known in the art, which enable computers to communicate. The computer network may be a local area network or wide area network such as the internet. The network may include modem lines, high speed dedicated lines, packet switches, etc. The network protocols used may include those known in the art such as UDP, TCP, IP, IPX, or the like. Additional communication protocols may be used to facilitate communication over the computer network 36, such as but not limited to the published HTTP protocol used on the World Wide Web, RPC, or other application protocols.

A social network as used in this network is generally an online service, platform, or site that focuses on building and reflecting of social relations among members who share interests, activities, friendship, familial relations, beliefs, or knowledge. A social network service typically has a profile of each member, a unique presentation layer, and a variety of additional services, such as application program interfaces (APIs). It is typically hosted on its own application server 40 environment. Well known social networks include Facebook™, Twitter™, LinkedIn™, Myspace™, and iTunes™. The system of the current invention can exist in its own independent social network. Alternatively, it can overlay or integrate with other social networks.

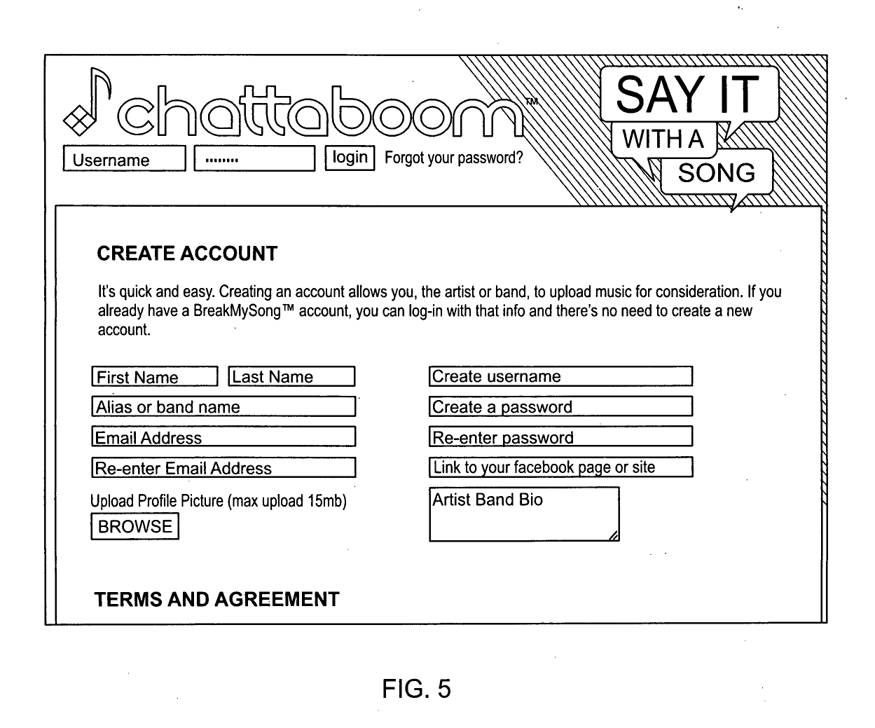

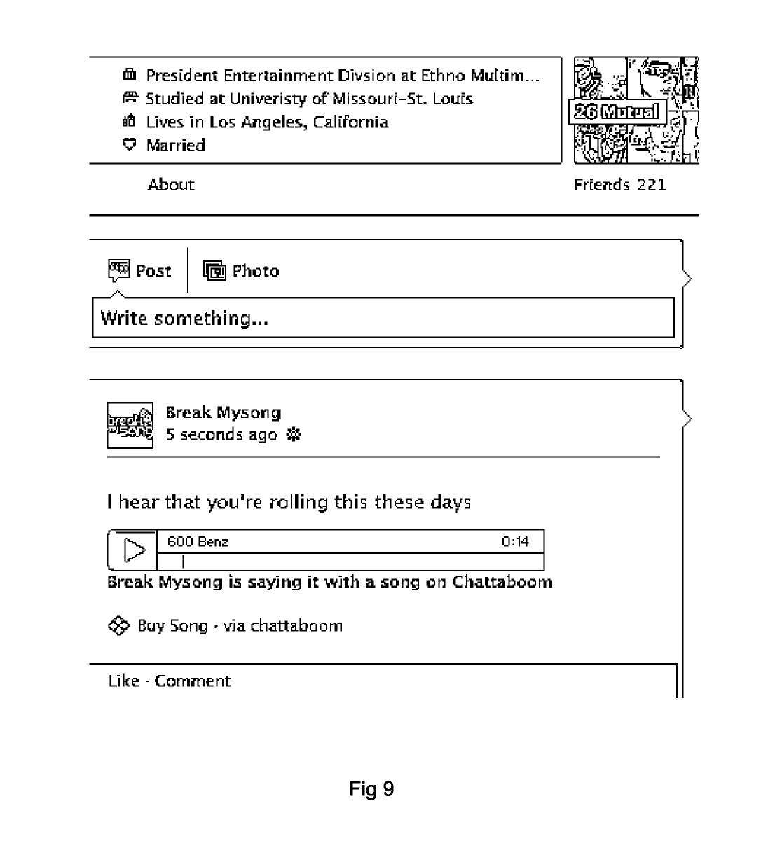

The client 38 of the current system varies according to the social network in which it operates. Where the system operates its own social network, the client may be a rich client or a web client. The search filter 22 and the presentation layer 26 layers vary with the client. For example, in a rich client on a personal computer, the search filter 24 may be robust and the presentation 26 complete. A client 38 on a mobile phone for a micro blogging platform may limit the search filter 22 and presentation 26 layers. As depicted in FIGS. 5-9, the client 38 can operate within the Facebook social network as a Facebook application.

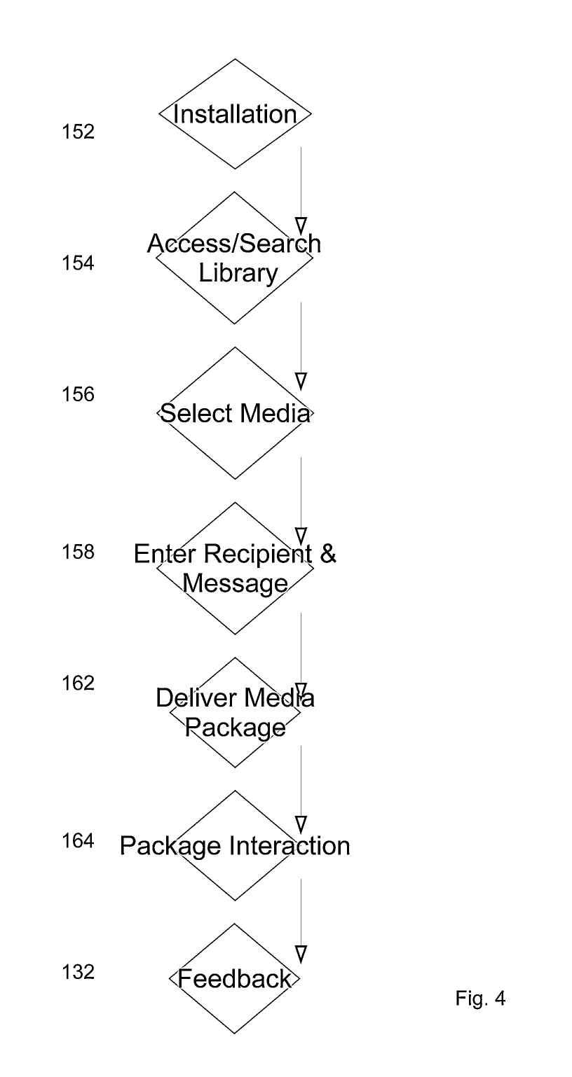

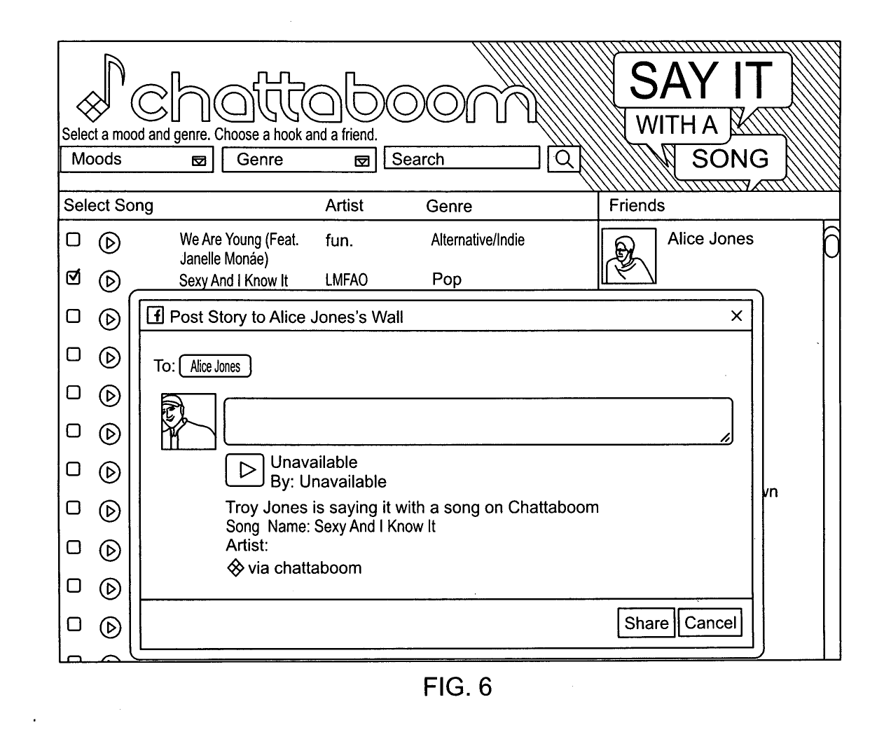

Having described the major elements of the system and process, FIG. 4 illustrates the process of a social network member using a client 38 to send a digital media package to a recipient. First the client 38 is installed on a computer 152. During installation and configuration of the illustrated client 38, the social media member creates a profile in the system, creating login information, entering contact information, social network memberships, and related information. The client 38 presents further configuration options such as retrieving affiliated members (“friends”) of the installing member for populating pick lists of possible recipients. Representative installation and setup screens are illustrated in FIGS. 5 and 6.

To continue the process of sending a digital media package, the sender accesses and searches the media library 154. The sender interacts with the client 38, which communicates with the application server 40. The application server 40, in turn, communicates with the media server 28 via the network 36 to search and access the media library 20. Based on the occasion for sending the digital media package, the sender searches on the keywords, moods, and genre. The sender is presented an input for entering a keyword search. The sender may enter words based on the occasion, lyrics, artist name, song titles, or other text. A text search input is shown in FIG. 6. the media containing the keywords are returned in the search results.

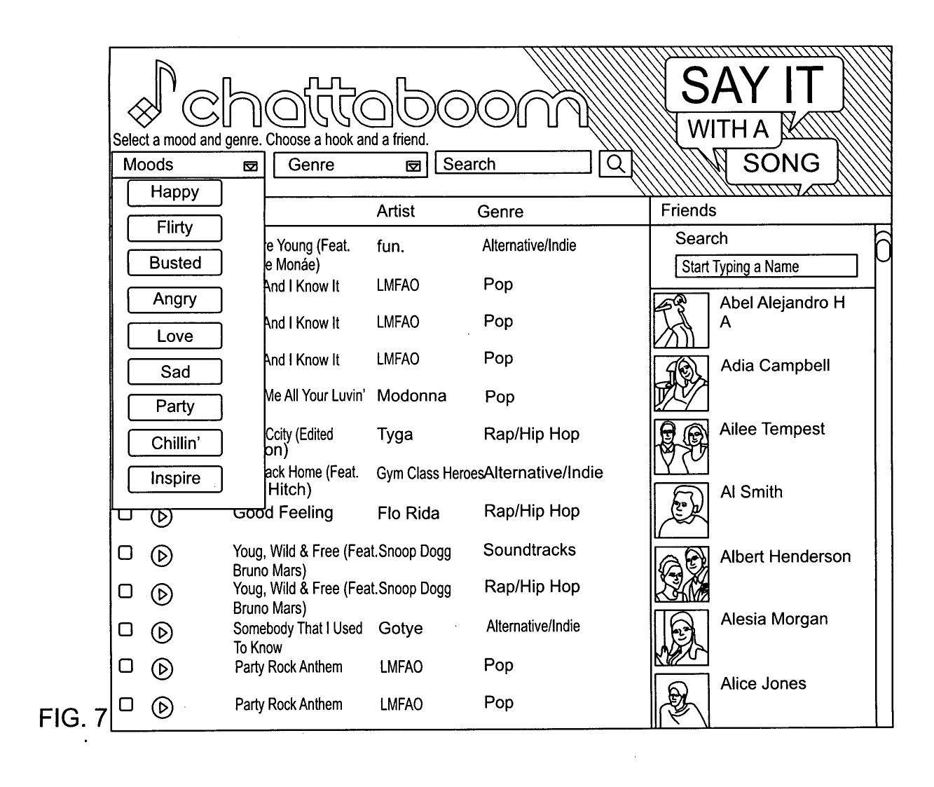

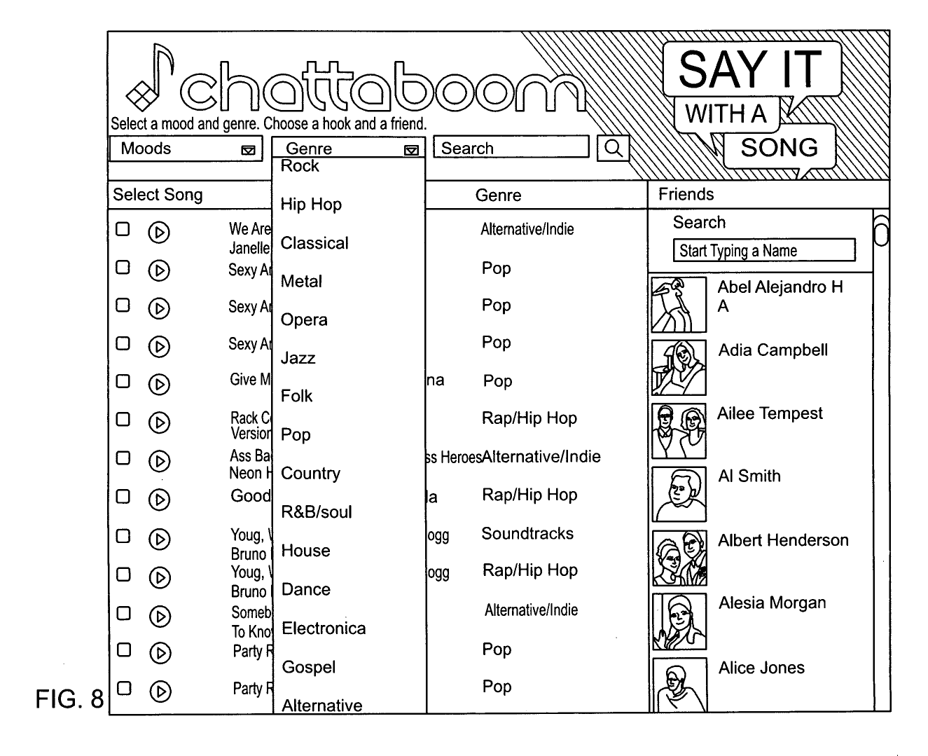

The sender is presented a list of moods and optionally colors associated with those moods. A mood pick list is shown in FIG. 7. Again, the media associated with the selected moods are returned in the search results. The sender is also presented a list of genre of music. A genre pick list is shown in FIG. 8. Again, the media associated with the selected moods are returned in the search results. The sender ultimately chooses a song (or other audio/video) for the media segment.

The sender enters or chooses a recipient for the digital media package and enters a personalized message 158. A digital media package is created, namely a data object containing necessary information for storage, presentation, and interaction with the media package in the social media environment. At this step, the digital media package contains the sender information, recipient information, the title of the song from which the media segment is derived, the author of the media, the personalized message from the sender, a link for review and purchase of the complete media file, secondary media, color coded images depicting the selected mood for the media package, the recipient's social network, the input search parameters, and other information necessary to store, present, and interact with the data object. Parts of the digital media package may reside in the client 38, the application server 40, and the media server 28.

A notice of the digital media package is sent or preferably posted in the recipient's social media space if the target platform supports such a posting format 162. A post in the recipient's social media space includes a presentation layer for the digital media package. The presentation layer preferably includes a media player for the recipient to listen to the media segment, the title of the song, the author of the media, a link for review and purchase of the complete media file, the sender's name, the sender's personalized message for the recipient, and color coded images depicting the selected mood for the message.

In the recipient's social media space, the recipient's network can interact with the digital media package. Members can post comments, members can rate, indicate positive (“Like”) or negative response, share the media, purchase the complete media, and the like. The interactions can be stored in the digital media package for subsequent processing by the system. The processing can be used as feedback 132 to further refine the media corresponding media data in the media library, further enhancing the search quality of the media library. For example, a given media package may attract multiple comments containing the same keyword. These keywords may or may not match the keywords that are associated with the media segment in the media library. Where the keywords do not match, those keywords may be associated with the media segment in the media library to improve future search results. Where the keywords match, a higher rank for those keywords may be assigned to that media segment.

Other interaction with the digital media package may be similarly processed by the system. The media package may receive high ratings in relation to some moods and different rating. Again, that feedback can increase the ability to accurately promote media to future users of the system, increasing the search quality for the potential senders and the viral potential for a given media segment in relation to certain keywords, moods, genre, and other filters.

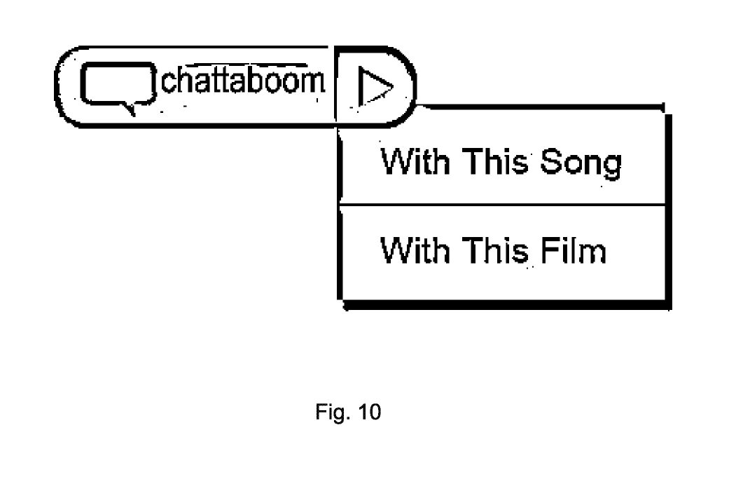

As mentioned, the system and process may exist in its own environment or integrate with other environments. FIG. 10 depicts an embedded object, which is one approach for integration into other environments. The depicted embedded object is a button preferably displayed in a media host. A media host is any data store capable of display or media. The typical media host is a webpage with audio. A media host may display the media as a downloadable/transferable or may stream the media. That webpage displays the embedded object, which can be activated to initiate the processes of the current system.

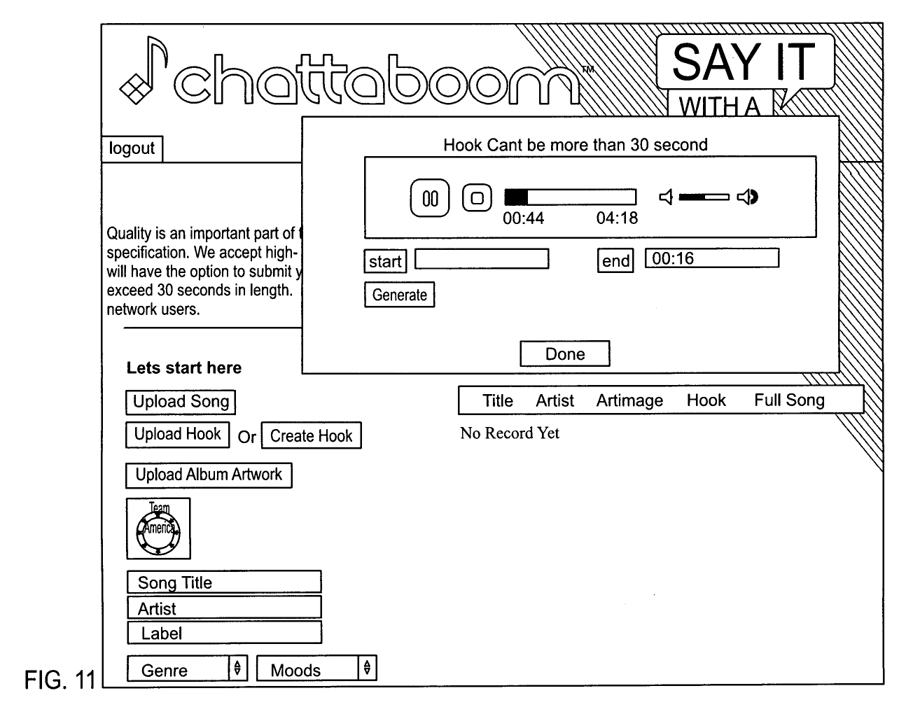

The user activates the embedded object, which enables the user to add content to the media library and deliver a digital media package to a recipient's social media environment similar to that discussed above. In the case of a media host that streams the media, the user starts playing the media, typically a music stream. Upon activation of the embedded object, the system captures the stream with software such as FFmpeg. The system presents the user an interface to input the data associated with the media, as disclosed above. A representative interface is shown in FIG. 11. Finally, the user may then select the desired recipient as describe above.

Insofar as the description above and the accompanying drawing disclose any additional subject matter that is not within the scope of the single claim below, the inventions are not dedicated to the public and the right to file one or more applications to claim such additional inventions is reserved.

What is claimed:

1. System and process for communication and promotion of a variety of media audio within a social network, that has been captured, stored, and categorized by moods and genres.

2. The system and process, wherein hooks or any portion of a recorded song is captured and categorized by moods, subject matter, and genre, then submitted to social networks as a way for users to communicate, discover, and purchase.

3. The system and process, wherein a portion of audio from TV shows are captured and categorized by moods, subject matter, and genre, then submitted to social networks as a way for a users to communicate, discover, and purchase.

4. The system and process, wherein a portion of audio from motion pictures are captured and categorized by moods, subject matter, and genre then submitted to social networks or as a way for users to communicate, discover, and purchase.

5. The system and process wherein a portion of audio from video news clips are captured and categorized by moods and subject matter, then submitted to social networks as a way for users to communicate, discover, and purchase.

6. The system and process of an embedded object integrated and displayed in an external media host for communication and promotion of audio within a social network.

7. The system and process in which musical artists can upload their digital music content to media library, extract hook or any other portion of their song, then assign a mood and genre to it.
